(19) United States
(12) Patent Application Publication
(10) Pub. No.: US 2024/0375263 A1
(43) Pub. Date: Nov. 14, 2024

(54) PORTABLE ADJUSTABLE WORK PLATFORM

(71) Applicant: 9050-7971 Quebec Inc, Sherbrooke (CA)

(72) Inventor: Derek TROTT, Sherbrooke (CA)

(73) Assignee: 9050-7971 Quebec Inc, Sherbrooke (CA)

(21) Appl. No.: 18/315,244

(22) Filed: May 10, 2023

(51) Int. Cl. B25H 1/00; B25H 1/04; B25H 1/16; E06C 7/44

(52) U.S. Cl. CPC B25H 1/0042; B25H 1/0035; B25H 1/04; B25H 1/16; E06C 7/44

(57) ABSTRACT

A portable work platform includes a top surface, a stationary plate coupled to the top surface, a pivot plate rotatably coupled to the stationary plate, an upper peg insertable through the stationary plate and the pivot plate for securing the pivot plate at a defined angle, and a plurality of leg assemblies coupled to the pivot plate, wherein rotation of the pivot plate provides rotation to the leg assemblies between an open and a closed state.

### FIELD OF THE DISCLOSURE

The present disclosure relates generally to work platforms and, more particularly, to a portable work platform for use on stairs or as a standalone platform with or without a ladder.

### BACKGROUND OF THE DISCLOSURE

When performing maintenance or construction work on a stairway or uneven surface, portable work platforms may be utilized to provide a stable work surface for storage or secure placement of a ladder. Traditional portable work platforms, however, may be limited to be only usable on stairways with a singular support. Further, work platforms dedicated to ladder-work on stairways may be semi-permanent installations during operation and may include additional surface components which may reduce available work space. Stairway work platforms may be further limited in use to specific, local rise-and-run parameters such that the work platform may not be universally employable. Traditional work platforms may be additionally limited in safety features and weight ratings, such that the use of these platforms in variable work conditions are restricted.

As such, a portable work platform which may be used on a variety of uneven surfaces or stairways, as well as a standalone work platform in general use, is desirable for maximum utility and safety.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a portable work platform includes a top surface, and at least one leg assembly pivotably coupled to the top surface and including an upper leg, and a lower leg telescopically couplable to the upper leg at any of a plurality of selectable locations.

In another embodiment, a portable work platform includes a top surface, a stationary plate coupled to the top surface, a pivot plate rotatably coupled to the stationary plate, an upper peg insertable through the stationary plate and the pivot plate for securing the pivot plate at a defined angle, and a plurality of leg assemblies coupled to the pivot plate, wherein rotation of the pivot plate provides rotation to the leg assemblies between an open and a closed state.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a schematic side view of a portable work platform.

FIG. 2A is a schematic view of an exterior slat of the top surface.

FIG. 2B is a schematic view of an interior slat of the top surface.

FIG. 2C is a schematic view of a surface brace of the top surface.

FIG. 3A is a schematic view of an upper leg of the leg assemblies.

FIG. 3B is a schematic view of a lower leg of the leg assemblies.

FIG. 4A is a schematic view of a stationary plate.

FIG. 4B is a schematic view of a pivot plate.

FIG. 5A is a schematic view of a foot for attachment to a lower leg of the leg assemblies.

FIG. 5B is a schematic view of a bumper for attachment to an upper leg of the leg assemblies.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to work platforms and, more particularly, to a portable work platform for use on stairs or as a standalone platform with or without a ladder. The portable work platform may include additional safety and stability features, with interlocking slats in the top surface and additional fasteners, along with surface braces and support steps, to enable higher weight loads to be safely placed on the top surface. The leg assemblies of the portable work platform may be rotatably coupled to the top surface such that the portable work platform may be used with all leg assemblies fully extended, or half of the leg assemblies fully extended to be used on a stairway or uneven surface. The leg assemblies of the portable work platform may be adjustable in height, such that the portable work platform may be raised or lowered as a standalone table, or adjusted to match the rise of a stairway or uneven surface. The leg assemblies of the portable work platform may provide grip on both the feet of each leg, as well as external surface of each leg, such that additional grip and friction may be provided in either the extended or folded state to provide slip resistance to the portable work platform.

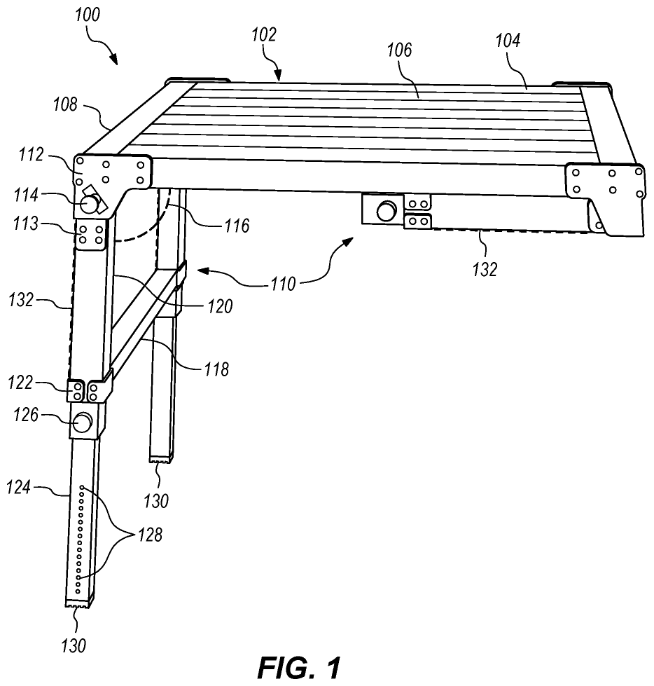

FIG. 1 is a schematic side view of a portable work platform 100. The portable work platform 100 (hereinafter. “the platform 100”) may be utilized as a standalone platform or on a plurality of stairs. The platform 100 may include a top surface 102 on which work may be performed, wherein the platform 100 may act as a table, may support a ladder on the top surface 102, or may support an operator. The top surface 102 may include a plurality of exterior slats 104 which may interlock with a plurality of interior slats 106 to form the top surface 102. The exterior slats 104 and interior slats 106 may be further mated with a plurality of fasteners for secure coupling to create the top surface 102. The top surface 102 may further include a plurality of endcaps 108, which may further mate or secure the plurality of exterior slats 104 and interior slats 106. In a non-limiting example, the top surface 102 may exhibit a length of about 29 inches and a width of about 24 inches.

The top surface 102 may be supported by a plurality of leg assemblies 110. In a nonlimiting example, as illustrated, the platform 100 may include two leg assemblies 110 which may each be rotatably or pivotably coupled to the top surface 102, for example via one or more stationary plates 112 mounted on the top surface 102, although other pivoting mechanisms are also contemplated. The stationary plates 112 may be rotatably coupled to one or more pivot plates 113 which are coupled to each leg assembly 110. The leg assemblies 110 may be locked into an open or closed position via one or more upper pegs 114 which may penetrate through both the stationary plates 112 and the pivot plates 113. Other locking mechanisms such as latches or the like are also contemplated. In the open position, the leg assemblies 110, when locked in the open position, may be maintained at an open angle 116 to provide a base of the leg assemblies 110 which is longer than the top surface 102. In a nonlimiting example, the open angle 116 may be 102° from the top surface 102, or 12° from vertical, to provide a more stable base of the leg assemblies 110. In some embodiments, the open angle 116 may be defined between about 90° and about 105° from the top surface 102, or 0° to 15° from vertical.

The leg assemblies 110 may include a support step 118 which may provide a crossbar for stability between each leg of the leg assemblies 110. The support step 118 may prevent lateral deflection of the leg assemblies 110, and may further provide a smaller surface for stepping or storage. The support steps 118 may be coupled to the upper legs 120 of the leg assemblies 110, wherein the upper legs 120 are mated to the top surface 102 via the stationary plates 112 and pivot plates 113. The support steps 118 may be mated to the upper legs 120 via one or more braces 122, such that the support steps 118 and upper legs 120 form a single reinforced piece. The one or more braces 122 may secure the support steps 118 and upper legs 120 via one or more fasteners as the coupling mechanism.

The upper leg 120 may contain all, or a portion, of a lower leg 124 within a hollow section of the upper leg 120, such that the lower leg 124 may be telescopically operable to extend and retract from the upper leg 120. The reverse configuration, whereby the upper leg 120 is telescopically mounted within the lower leg 124, is also contemplated. The lower leg 124 may be locked into an extended or retracted position using one or more lower pegs 126, which may penetrate through both the upper leg 120 and lower leg 124 such that the lower leg is telescopically couplable with the upper let at any of a plurality of selectable locations. In some embodiments, the one or more lower pegs 126, as well as the one or more upper pegs 114, may be spring-loaded such that the lower pegs 126 or the upper pegs 114 are naturally biased toward the locked position in which the lower leg 124 is immovable. The spring-loaded mechanism may be operable to uncouple the lower leg 124 from the upper leg 120 and enable extension or retraction of the lower leg 124 while the lower pegs 126 are retracted. In a further embodiment, the lower pegs 126 and the upper pegs 114 may be locking pins which may be secured in place when locked, and fully removed during the extension or retraction process. Locking mechanisms in lieu of pegs, such as latches and the like, are also contemplated.

The one or more lower pegs 126 may penetrate through the upper leg 120 and into one of a plurality of holes 128 defined within the lower leg 124. The plurality of holes 128 may be spaced at a set distance, such that the leg assemblies 110, and the platform 100, may be adjustable to varying heights. In a non-limiting example, the plurality of holes 128 may be defined at spacings from about ¼ of an inch to about ⅜ of an inch. However, those skilled in the art will readily appreciate that the spacing of the plurality of holes 128 may be greater or less than this range without departing from the scope of this disclosure.

The leg assemblies 110 may include a foot 130 on at least one of the lower legs 124, which may include a grip material to prevent undesired movement of the base of the platform 100. In a nonlimiting example, the grip material may comprise neoprene for provision of increased grip on the foot 130. In further examples, however, any grip material may be used including natural rubber. Similar grip materials may be utilized for one or more bumpers 132 which may be installed on an exterior side face of the upper legs 120, such that grip may be provided on the exterior surface of the upper legs 120 when in the closed—that is, folded or collapsed-position. The presence of bumpers 132 on the side surface of the leg assemblies (one or both leg assemblies 110 may thus include the bumper) may enable a half-closed platform to be positioned on any two surfaces at different heights, such that a stable platform 100 may be utilized on uneven or raised surfaces.

Through the adjustable height of the platform 100, the gripping surfaces on the bottom of the open leg assemblies 110, on the exterior surface of the closed leg assemblies 110, and the locking mechanisms provided by the upper pegs 114 and lower pegs 126, the platform 100 may be utilized as a standalone table, as a flat work surface on a stairway, or as a step for an operator. The platform 100 may be variable in height to match the rise and run of a standard stairway, such that the platform 100 may be used as a ladder platform for stable work on stairs. The interlocking, fastened, top surface 102, as well as the support steps 118 provided within the leg assemblies 110, may provide a stable surface for the support of a ladder, an operator, a variety of tooling or materials, or any combination thereof. In a non-limiting example, the platform 100, as illustrated, may be rated to support up to about 350 pounds of weight. One particularly useful application is on different stairway steps having different heights, such that the top surface 102 of the platform 100 can remain flat or horizontal, for example to support a ladder thereon. This can be accomplished by folding or collapsing one of the leg assemblies 110 (the right-side leg assembly is shown in this folded configuration in FIG. 1), and resting the folded leg assembly on the higher step of the stairway, with the bumper 132 positioned on the surface of the higher step for improved purchase, while the unfolded (left-side) leg assembly rests on the lower step of the stairway (or on the ground) with the foot 130 positioned on the surface of the lower step (or ground).

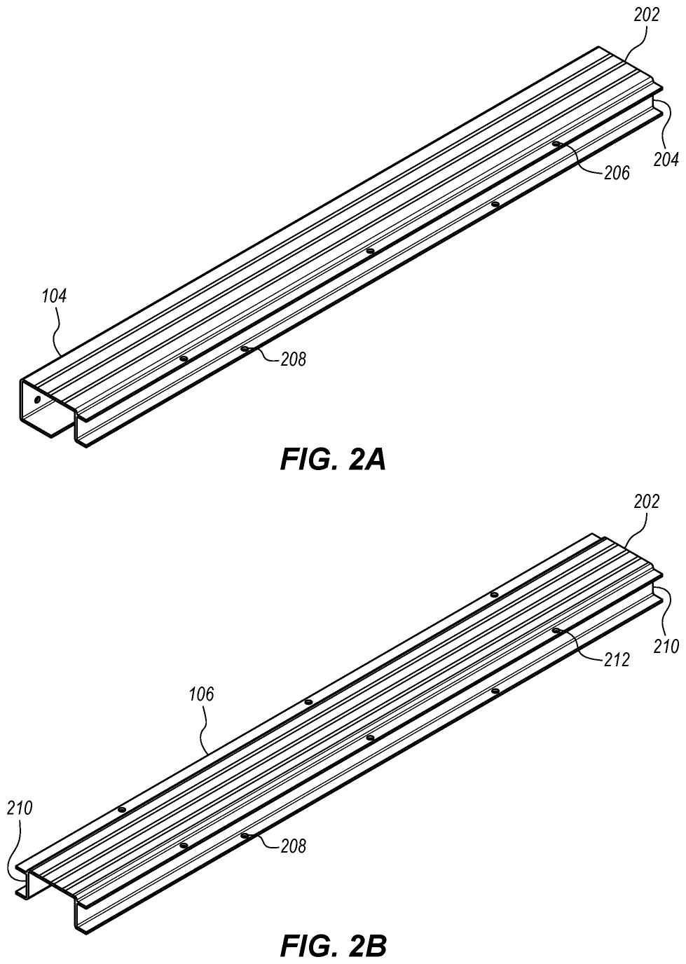

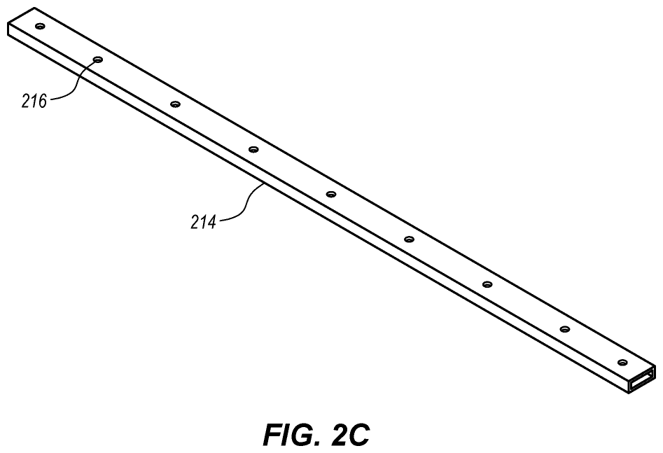

FIG. 2A is a schematic view of an exterior slat 104, according to certain embodiments. A plurality—for example four—of exterior slats 104 may be utilized in the formation of the top surface 102 of FIG. 1. The exterior slat 104 may include one or more grooves 202 on the top face of the exterior slat 104, such that additional traction may be provided on the working surface. Texturing or other features may be provided to improve traction and reduce slippage. The exterior slat 104 may further define a slot 204 on one side of the body, such that the exterior slat 104 may be slidingly engageable with an interior slat 106 of FIG. 1. Additionally, the exterior slat 104 may define a plurality of holes 206 within the slot 204, through which a plurality of fasteners may be employed to secure and further mate the exterior slat 104 with an interior slat 106 of FIG. 1. The exterior slat 104 may further include a plurality of holes 208 on the bottom of the slot 204, such that a surface brace (not shown) may be installed via a plurality of fasteners to provide additional support to the top surface 102 of FIG. 1.

FIG. 2B is a schematic view of an interior slat 106, according to certain embodiments. The interior slat 106 may include one or more grooves 202 or texturing similar to the grooves 202 of the exterior slat 104 of FIG. 2A, such that the additional traction and surface area may be consistent across the assembled top surface 102 of FIG. 1. The interior slat 106 may include two interior slots 210 which may be slidingly engageable with the slot 204 of the exterior slat 104 of FIG. 2A, or with interior slots 210 of further interior slats 106 to form the top surface 102 of FIG. 1. Similar to the exterior slat 104 of FIG. 2A, the interior slat 106 may define a plurality of holes 212 in the top face of the interior slots 210, through which a plurality of fasteners may be inserted to further mate and secure the components of the top surface 102 of FIG. 1. The plurality of holes 212 may align with the plurality of holes 206 of the exterior slat 104 of FIG. 2A, or with the plurality of holes 212 of further interior slats 106, such that the plurality of fasteners may be inserted through multiple components for additional mating and security. The interior slat 106 may further define a plurality of holes 208 in the bottom of the interior slots 210 such that a surface brace (FIG. 2C) may be installed via a plurality of fasteners to provide additional support to the top surface 102 of FIG. 1.

FIG. 2C is a schematic view of a surface brace 214, according to certain embodiments. The surface brace 214 may be installed on the underside the top surface 102 of FIG. 1, such that the exterior slat 104 of FIG. 2A and the interior slat 106 of FIG. 2B may be further mated and secured. The surface brace 214 may provide additional stability and security to the top surface 102 of FIG. 1, and may define a plurality of holes 216 within the body of the surface brace 214. The plurality of holes 216 may align with the holes 208 of the exterior slat 104 and interior slat 106 of FIGS. 2A and 2B, such that the plurality of fasteners may penetrate through one or more components of the top surface 102 of FIG. 1.

The multiple mechanisms seen in FIGS. 2A-2C for mating and securing the components of the top surface 102 of FIG. 1 may provide a more secure top surface 102 upon which work may be performed, an operator may stand, or a ladder may be placed. The further support provided by the multiple mechanisms and the surface brace 214 may enable a greater degree of safety and weight rating for the platform 100, while maintaining the overall low weight and portability of the platform 100, for example through the use of the substantially hollow interior (106) and exterior (104) slats, and the upper (120) and lower (124) legs as further detailed below:

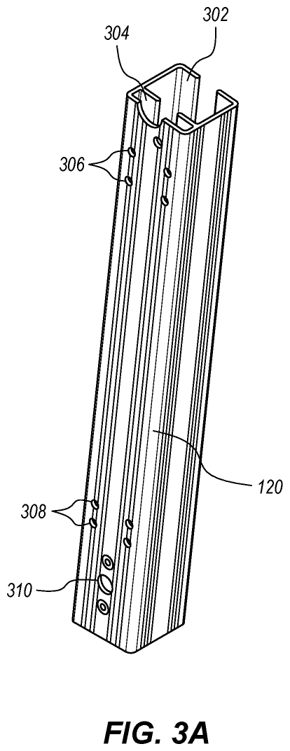

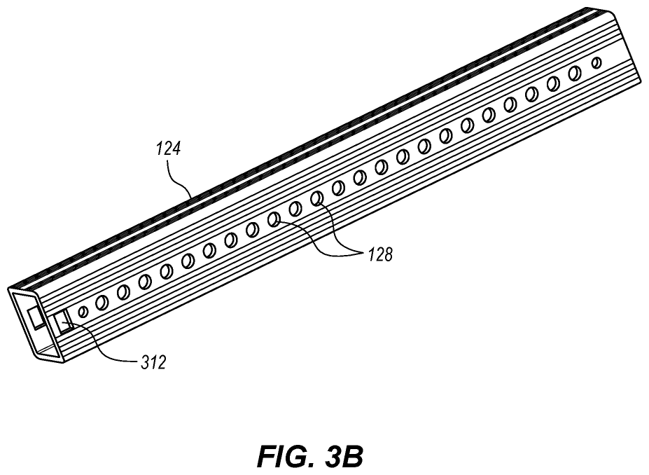

FIG. 3A is a schematic view of an upper leg 120, according to certain embodiments. The upper leg 120 may include a primary interior slot 302, in which the lower leg 124 of FIG. 1 may be inserted and retained. The upper leg 120 may further include a secondary interior slot 304 in which fasteners may be inserted and secured, such that the fasteners do not interfere with the telescoping travel of the lower leg 124 of FIG. 1. The upper leg 120 may define an upper plurality of holes 306, through which fasteners may be inserted to secure a pivot plate 113 of FIG. 1, such that the upper leg 120 may be rotatably coupled to the top surface 102 of FIG. 1. Further, the upper leg 120 may define a lower plurality of holes 308 through which fasteners may be inserted to secure the one or more braces 122 of FIG. 1 for retaining and mating the support steps 118 of FIG. 1 to the upper leg 120. The upper leg 120 may further define a peg hole 310, through which the lower peg 126 of FIG. 1 may be inserted through such that the lower leg 124 of FIG. 1 may be locked in place within the primary interior slot 302 of the upper leg 120.

FIG. 3B is a schematic view of an lower leg 124, according to at least one embodiment of the present disclosure. The lower leg 124, as previously discussed, may define a plurality of holes 128 through which the lower peg 126 of FIG. 1 may be inserted to retain the lower leg 124 at the desired height. The lower leg 124 may further define a plurality of slots 312 for mating of the lower leg 124 to the foot 130 of FIG. 1.

The variability provided by the upper leg 120 and the lower leg 124 of FIGS. 3A-3B may enable the platform 100 of FIG. 1 to be useful at a number of heights and enable the platform to match the rise and run of a plurality of stairs, such that the platform 100 of FIG. 1 may be utilized in a variety of situations.

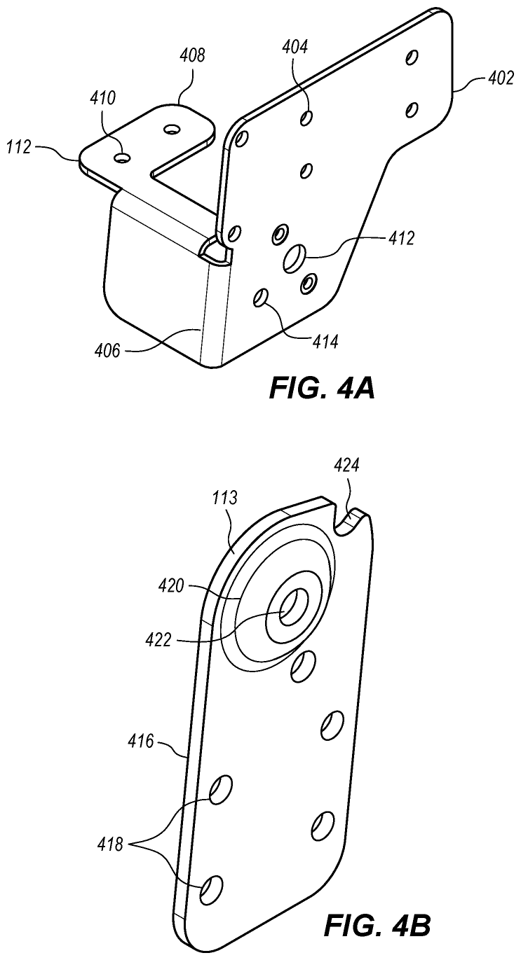

FIG. 4A is a schematic view of a stationary plate 112, according to certain embodiments. The stationary plate 112 may define a flat plate 402 in which a plurality of holes 404 may be defined for mounting the stationary plate 112 to the top surface 102 (FIG. 1). The flat plate 402 may be sized to match the profile of the corner of the top surface 102 and leg assemblies 110 of FIG. 1, such that the stationary plate 112 may add further structural integrity and stability to the platform 100 of FIG. 1. The flat plate 402 may be joined or otherwise formed to a bent portion 406 of the stationary plate 112, such that a corner brace structure may be formed around the defined corner. The bent portion 406 may be further shaped to define a shelf 408 on which the top surface 102 of FIG. 1 may be additionally supported. The shelf 408 may define one or more shelf holes 410 which may enable further fasteners to be inserted through the top surface 102 of FIG. 1 and provide additional stability and integrity. The flat plate 402 may further define a peg hole 412 through which the upper peg 114 of FIG. 1 may be inserted to lock or unlock the rotation mechanism of the platform 100 of FIG. 1. The flat plate 402 may additionally define a pin hole 414, through which a pin (not shown) may be inserted to serve as a point of rotation or axle between the stationary plate 112 and the pivot plate 113 of FIG. 1.

FIG. 4B is a schematic view of a pivot plate 113, according to certain embodiments. The pivot plate 113 may define a flat plate 416 in which a plurality of holes 418 may be defined. The plurality of holes 418 may enable mounting and mating of the pivot plate 113 to the upper leg 120 of FIGS. 1 and 3A. The pivot plate 113 may define a raised, rounded portion 420 in which a pin hole 422 may be defined. The pin hole 422 may enable a central pin or axel (not shown) to be installed, such that the pivot plate 113 may rotate about the pin hole 422 to open or close the leg assemblies 110 of FIG. 1. The raised portion 420 may reduce the friction of the rotation between the pivot plate 113 and the stationary plate 112 of FIG. 4A. The pivot plate 113 may define a peg notch 424, in which the upper peg 114 of FIG. 1 may be retained and locked when the leg assemblies 110 of FIG. 1 are opened and extended. In at least one embodiment, the peg notch 424 may defined such that the pivot plate 113 and any attached leg assemblies 110 of FIG. 1 may be maintained at a 12° angle from vertical, or 102° from the top surface 102 of FIG. 1 when fully opened and locked in place.

The stationary plate 112 and pivot plate 113 of FIGS. 4A-4B may provide additional structural integrity, reduced lateral motion, and the rotational capabilities to the leg assemblies 110 and platform 100 of FIG. 1. The defined peg notch 424 of the pivot plate 113 may enable the locking of the leg assemblies 110 of FIG. 1 at a predefined, optimal angle for stability and safety, while maintaining a desirable size and portability. Further, the rotational capabilities provided by the pivot plate 113 may enable the collapsing or closing of one or more leg assemblies 110 of FIG. 1, such that the platform 100 of FIG. 1 may be utilized as a stable work surface on flat ground, uneven surfaces, or on a plurality of stairs.

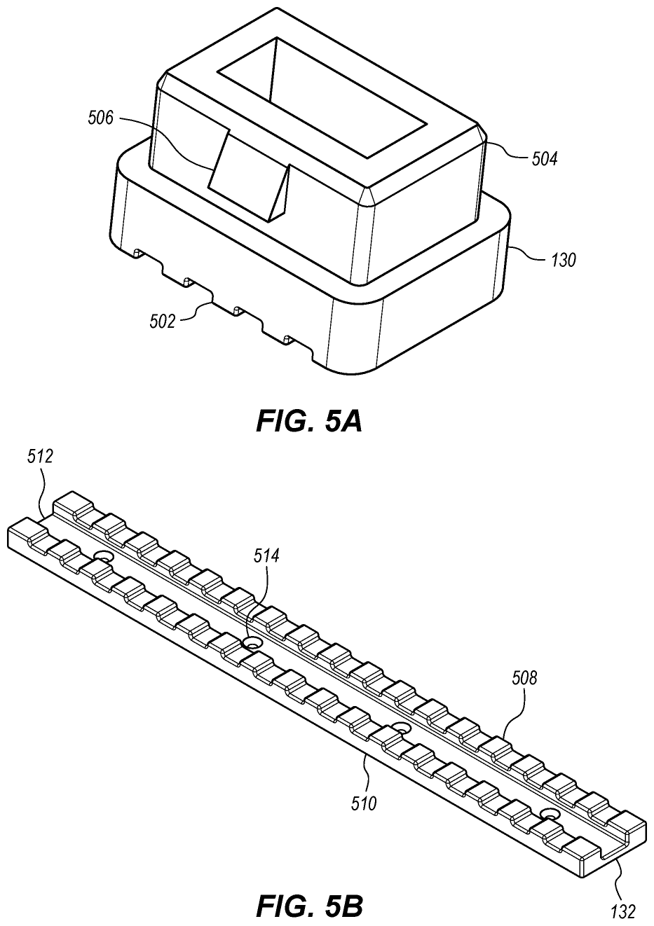

FIG. 5A is a schematic view of a foot 130, according to certain embodiments. The foot 130, as previously described, may be formed of a grip material, such as neoprene, such that the platform 100 of FIG. 1 may rest on higher-friction supports and may resist undesired motion of the work platform due to sliding. The foot 130 may include a textured bottom 502, formed of the grip material, such that the textured bottom 502 may provide additional surface area for enhanced grip of uneven or slick surfaces. The foot 130 may include a tapered top portion 504, such that the foot 130 may be at least partially inserted into the lower leg 124 of FIG. 3B. The tapered top portion 504 may further define one or more sloped protrusions 506 such that the foot 130 may mate with the slots 312 of the lower leg 124 of FIG. 3B.

FIG. 5B is a schematic view of a bumper 132, according to certain embodiments. The bumper 132 may define a textured bottom side 508, which may be formed of the previously described grip material, such that the leg assemblies 110 of FIG. 1 may provide similar frictional and stability characteristics as the foot 130 of FIG. 5A when in the closed position. The bumper 132 may define a flat top side 510, such that the bumper 132 may be installed flat against an exterior surface of the upper leg 120 of FIG. 3A. The bottom side 508 of the bumper 132 may define a groove 512 between textured regions, in which one or more holes 514 are defined. The one or more holes 514 may enable the insertion of one or more fasteners, such that the bumper 132 may be retained on the exterior side the upper leg 120, as seen in FIG. 1. The groove 512 may enable heads of the one or more fasteners to project from the bumper 132 without affecting the grip of the textured regions.

The grip material and textured nature of both the foot 130 and bumper 132 of FIGS. 5A-5B may enable the platform 100 of FIG. 1 to provide added safety to an operator, such that the platform 100 of FIG. 1 may be secure when used as a standalone table, or as a half-extended work platform on a plurality of stairs. The gripping nature of these components may enable use on slick or uneven surfaces with a lower risk of sliding or shifting while used with ladder operations or while supporting an operator.

Embodiments disclosed herein include:
A. A portable work platform comprising a top surface, and at least one leg assembly pivotably coupled to the top surface and including an upper leg, and a lower leg telescopically couplable to the upper leg at any of a plurality of selectable locations.
B. A portable work platform comprising a top surface, a stationary plate coupled to the top surface, a pivot plate rotatably coupled to the stationary plate, an upper peg insertable through the stationary plate and the pivot plate for securing the pivot plate at a defined angle, and a plurality of leg assemblies coupled to the pivot plate, wherein rotation of the pivot plate provides rotation to the leg assemblies between an open and a closed state.

Each of embodiments A and B may have one or more of the following additional elements in any combination: Element 1: wherein each of the upper and lower legs includes one or more holes for receiving a removable peg for fixing the relative position of the upper and lower legs. Element 2: wherein the one or more holes of the upper or lower legs are spaced about ¼ to ⅜ of an inch apart. Element 3: wherein the at least one leg assembly comprises one or more braces matable with the upper leg, and one or more support steps matable with the one or more braces and a plurality of upper legs. Element 4: wherein the at least one leg assembly comprises one or more feet matable with the lower leg comprising a textured bottom formed of a grip material. Element 5: wherein the grip material comprises neoprene. Element 6: wherein the at least one leg assembly includes a bumper mounted to a side thereof. Element 7: wherein the bumper a textured top surface formed of a grip material. Element 8: further comprising a stationary plate coupled to the top surface, a pivot plate rotatably coupled to the stationary plate, and an upper peg insertable through the stationary plate and the pivot plate for securing the pivot plate at a defined angle, wherein the pivot plate is coupled to at least one leg assembly, and wherein rotation of the pivot plate rotates the at least one leg assembly between an open and a closed position. Element 9): wherein the top surface comprises one or more exterior slats and one or more interior slats slidingly engageable to form the top surface. Element 10: wherein the pivot plate comprises a peg notch mateable with the upper peg for securing the pivot plate at the defined angle. Element 11: wherein the peg notch defines the defined angle between 90° and 105° from the top surface. Element 12: wherein the pivot plate further comprises a raised, rounded portion through which a pin or axel is inserted for rotation. Element 13: wherein the plurality of leg assemblies comprise an upper leg defining an interior slot, a lower leg insertable into the interior slot of the lower leg, and a lower peg insertable through the upper leg and the lower leg for securing the lower leg in place at a set height. Element 14: further comprising one or more feet matable with the lower leg comprising a textured bottom formed of a grip material, and one or more bumpers matable with the upper leg comprising a textured top surface formed of the grip material.

By way of non-limiting example, exemplary combinations applicable to A and B include: Element 1 with Element 2: Element 4 with Element 5: Element 6 with Element 7; Element 10 with Element 11; and Element 10 with Element 12.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including.” “comprises”, and/or “comprising.” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A portable work platform comprising:
a top surface; and
at least one leg assembly pivotably coupled to the top surface and including:
an upper leg, and
a lower leg telescopically couplable to the upper leg at any of a plurality of selectable locations.

2. The portable work platform of claim 1, wherein each of the upper and lower legs includes one or more holes for receiving a removable peg for fixing the relative position of the upper and lower legs.

3. The portable work platform of claim 2, wherein the one or more holes of the upper or lower legs are spaced about ¼ to ⅜ of an inch apart.

4. The portable work platform of claim 1, wherein the at least one leg assembly comprises:
one or more braces matable with the upper leg; and
one or more support steps matable with the one or more braces and a plurality of upper legs.

5. The portable work platform of claim 1, wherein the at least one leg assembly comprises one or more feet matable with the lower leg comprising a textured bottom formed of a grip material.

6. The portable work platform of claim 5, wherein the grip material comprises neoprene.

7. The portable work platform of claim 1, wherein the at least one leg assembly includes a bumper mounted to a side thereof.

8. The portable work platform of claim 7, wherein the bumper a textured top surface formed of a grip material.

9. The portable work platform of claim 1, further comprising:
a stationary plate coupled to the top surface;
a pivot plate rotatably coupled to the stationary plate; and
an upper peg insertable through the stationary plate and the pivot plate for securing the pivot plate at a defined angle, wherein the pivot plate is coupled to at least one leg assembly, and wherein rotation of the pivot plate rotates the at least one leg assembly between an open and a closed position.

10. The portable work platform of claim 1, wherein the top surface comprises one or more exterior slats and one or more interior slats slidingly engageable to form the top surface.

11. A portable work platform comprising:
a top surface;
a stationary plate coupled to the top surface;
a pivot plate rotatably coupled to the stationary plate;
an upper peg insertable through the stationary plate and the pivot plate for securing the pivot plate at a defined angle; and
a plurality of leg assemblies coupled to the pivot plate, wherein rotation of the pivot plate provides rotation to the leg assemblies between an open and a closed state.

12. The portable work platform of claim 11, wherein the pivot plate comprises a peg notch mateable with the upper peg for securing the pivot plate at the defined angle.

13. The portable work platform of claim 12, wherein the peg notch defines the defined angle between 90° and 105° from the top surface.

14. The portable work platform of claim 12, wherein the pivot plate further comprises a raised, rounded portion through which a pin or axel is inserted for rotation.

15. The portable work platform of claim 11, wherein the plurality of leg assemblies comprise:
an upper leg defining an interior slot;
a lower leg insertable into the interior slot of the lower leg; and
a lower peg insertable through the upper leg and the lower leg for securing the lower leg in place at a set height.

16. The portable work platform of claim 11, further comprising:
one or more feet matable with the lower leg comprising a textured bottom formed of a grip material; and
one or more bumpers matable with the upper leg comprising a textured top surface formed of the grip material.
